(19) United States
(12) Patent Application Publication
(10) Pub. No.: US 2021/0212332 A1
(43) Pub. Date: Jul. 15, 2021

(54) TWO SELECTIVE MODULES FOR A CONTROLLED ATMOSPHERE CONTAINER

(71) Applicant: Maersk Container Industry A/S, Tinglev (DK)

(72) Inventors: Niels Nielsen POULSEN, Tinglev (DK); Poul Kim MADSEN, Tinglev (DK)

(21) Appl. No.: 15/733,989

(22) PCT Filed: May 29, 2019
(86) PCT No.: PCT/EP2019/063981

§ 371 Date: Dec. 1, 2020

(30) Foreign Application Priority Data
Jun. 1, 2018 (DK) PA201870321

(51) Int. Cl. A23B 7/148; B65D 88/74; B01D 53/22; B01D 53/04

(52) U.S. Cl. CPC A23B 7/148; B65D 88/745; B01D 53/229; B01D 53/226; B01D 2256/10; B65D 2588/746; A23V 2002/00; B01D 2257/504; B01D 2257/104; B01D 53/0407

(57) ABSTRACT

The invention relates to a reefer container (1) having a controlled atmosphere system (3) comprising:—a first selective unit (4) comprising an absorber or a membrane (9) being selective for carbon dioxide over oxygen and nitrogen;—a second selective unit (11) comprising an absorber or a membrane (14) being selective for oxygen over nitrogen; and—a vacuum pump (6) for extracting and removing separated gasses from a permeate side (8, 13) of the first and second selective units (4, 11) to outside the container(1), where the system (3) is further comprising a pump (15) for providing an overpressure in the container(1). The pump (15) can be connected to the container (1) through a feed side (12) of the second selective unit (11). The invention further relates to a method of controlling reefer container (1) having a controlled atmosphere system (3).

The invention relates to a reefer container having a controlled atmosphere system comprising:
a first selective unit comprising an absorber or a membrane being selective for carbon dioxide over oxygen and nitrogen;
a second unit comprising an absorber or a membrane being selective for oxygen over nitrogen; and
a vacuum pump for extracting and removing separated gasses from a permeate side of the first and second selective units to outside the container; and where the system is further comprising a pump for providing an overpressure in the container through the second selective unit.

The invention further relates to a method of controlling the atmosphere within a reefer container having a controlled atmosphere system comprising:
a first selective unit comprising an absorber or a membrane being selective for carbon dioxide over oxygen and nitrogen;
a second unit comprising an absorber or a membrane being selective for oxygen over nitrogen; and
a vacuum pump for extracting and removing separated gasses from a permeate side of the first and second selective units to outside the container.

Controlled atmosphere within a reefer container is used to control the composition of gasses within the container to be able to prolong shelf life of the transported produce.

From WO2004107868 A1 is known a reefer container having an apparatus for controlling the composition of gases within the container. The apparatus includes at least one sensor, at least one controller and at least one gas permeable membrane being adapted to facilitate the passage there through of different molecules at different rates. The membrane separates the container into a first region and a second region, the first region being for holding cargo, and the second region defining a gas buffer region, where at least one inlet and/or outlet communicate(s) with the buffer region.

The membrane defines a first region and a second region, the first region being for holding cargo and the second region forms a gas buffer region, and the at least one inlet and/or outlet is in communication with said buffer region.

The membrane is permeable and is adapted to facilitate the transportation of different molecular species through the barrier (membrane) at different rates.

The permeation of materials through the membrane will be driven by the relative material properties, partial pressure and/or polarity differentials of the molecules which are applied to sides of the membrane.

From U.S. Pat. No. 8,177,883 it is known to have a vacuum pump in fluid connection with a buffer region of a membrane unit. Operating the membrane unit with a vacuum pump providing a sub ambient pressure makes it possible to achieve high concentration of carbon dioxide in the permeate without oxygen is being let into the container via the membrane.

From WO14078833 A1 is known a membrane separation process for controlling relative concentrations of carbon dioxide, oxygen, and nitrogen within a shipping or storage container for respiring produce. The process uses a first membrane that is selective to carbon dioxide over oxygen and nitrogen, and a second membrane that is selective to oxygen over nitrogen. The first and second membranes are placed in first and second membrane units, which units are in fluid connection with a vacuum pump.

The first and second membrane units are each divided in a feed side and a permeate side by a membrane. The permeate side of the membrane units is in fluid connection with the vacuum pump. Removal of a first, carbon dioxide-enriched permeate stream causes pressure within the container to drop to less than the pressure outside the container, which is usually atmospheric. This pressure differential gives rise to a flow of air into the container. Make-up air enters the process or system as fresh intake air stream, from the ambient outside environment. In other words, this stream is drawn into the system or process in an essentially passive, unregulated manner, in response only to the reduced pressure inside the container brought about by operation of the first membrane separation unit or step.

Thus, passage of make-up gas into the container is free of control by sensors, switches, valves, regulators, or any other type of control or regulating equipment. The passage is therefore open to the outside environment, and connects freely and openly with the interior of the container. Such a system will in the following be referred to as a passive controlled atmosphere system.

It is also known to purge the container with an inert gas supplied from a gas cylinder thereby displacing the normal atmospheric content (including oxygen) to maintain and prolong the storage life of oxidizable items stored therein. Such an inert gas can be nitrogen. A drawback, when using controlled atmosphere systems, is that the nitrogen will partly be removed from the cargo space of the container.

Reefer containers are to some extend leaky, wherefore there are special requirements for controlled atmosphere (CA) containers, which incl. installing of a controlled atmosphere (CA) curtain in the door-end of the reefer container and passing a well-defined tightness prior controlled atmosphere (CA) transport—known as a controlled atmosphere (CA) leak test.

Inside the reefer container, there exist during operation different pressure regions, caused by the evaporator fans producing overpressure and the cargo providing pressure drop.

When operating in controlled atmosphere (low oxygen high carbon dioxide) a significant partial pressure difference of these molecules vs. ambient exist—the force of diffusion together with small air gaps (leakages) and the different pressure regions caused by the evaporator fan will to some extend result in ingress of unwanted ambient air (21% oxygen).

In the following, a system is described, making a controlled atmosphere system more robust when transporting low respiring commodities. Examples of a low respiring commodity can be apples or lettuce.

This is solved by a reefer container having a controlled atmosphere system comprising:
a first selective unit comprising an absorber or a membrane being selective for carbon dioxide over oxygen and nitrogen;
a second unit comprising an absorber or a membrane being selective for oxygen over nitrogen; and
a vacuum pump for extracting and removing separated gasses from a permeate side of the first and second selective units to outside the container; and where the system is further comprising a pump for providing an overpressure in the container through the second selective unit.

This system can be described as an active controlled atmosphere system, which system acts by over-purging nitrogen enriched atmosphere into the controlled atmosphere reefer container by use of the second selective unit.

A second selective unit, a nitrogen enrichment unit is incorporated, which is operated with the same vacuum pump as the first selective unit to ensure that replacement atmosphere can contain 2-7%, preferably 2-4% oxygen instead of 21% oxygen, making overall oxygen mass balance more tolerant to low commodity respiration and to air leakages through the container wall or container doors.

In an embodiment, the pump is connected to the container through a feed side of the second selective unit resulting in a forced flow of nitrogen enriched gas into the container.

When forcing ambient atmosphere through the feed side of the second selective unit by a pump, nitrogen concentration is increased in the ingoing flow and the ingoing nitrogen enriched flow into the container is larger than outgoing permeate (concentrated oxygen+carbon dioxide+nitrogen+water vapor) from the cargospace of the container via the first and second selective units.

In an embodiment, the pump is a positive displacement pump.

In an embodiment the flow of enriched nitrogen pressed into container by the pump is larger than flow out of container from the permeate side of the first selective unit.

In an embodiment the flow of enriched nitrogen pressed into container by the pump is 10% larger than flow out of container from the permeate side of the first selective unit.

In an embodiment the flow of enriched nitrogen pressed into container by the pump is 25% larger than flow out of container from the permeate side of the first selective unit.

In an embodiment the flow of enriched nitrogen pressed into container by the pump is 50 litre per hour (L/h) larger, preferable 100 L/h larger, more preferable 200 L/h larger than flow out of container from the permeate side of the first selective unit.

In an embodiment the flow of enriched nitrogen pressed into container by the pump is more than 200 L/h larger than flow out of container from the permeate side of the first selective unit.

In a situation where the carbon dioxide level is on a level not requiring operation of the first selective unit, the second selective unit can be operated or controlled alone via a controller and valves, pressing nitrogen enriched gas into the reefer container.

In an embodiment the vacuum pump for removing permeate from the selective units is driven by a shaft also driving the pump forcing ambient atmosphere through the feed side of the second membrane unit.

In an embodiment the first selective unit is placed in a cargo space of the container.

It is further solved by a method of controlling the atmosphere within a reefer container having a controlled atmosphere system comprising:
a first selective unit comprising an absorber or a membrane being selective for carbon dioxide over oxygen and nitrogen;
a second unit comprising an absorber or a membrane being selective for oxygen over nitrogen; and
a vacuum pump for extracting and removing separated gasses from a permeate side of the first and second selective units to outside the container; and where an overpressure is provided in the container through the second selective unit by a pump.

A problem, which is solved by the invention is to achieve a better controlled atmosphere in the cargo region of a container, eliminating influence from leaks in the container.

The above and other features and advantages of the present invention will become readily apparent to those skilled in the art by the following detailed description of exemplary embodiments thereof with reference to the attached drawings, in which:

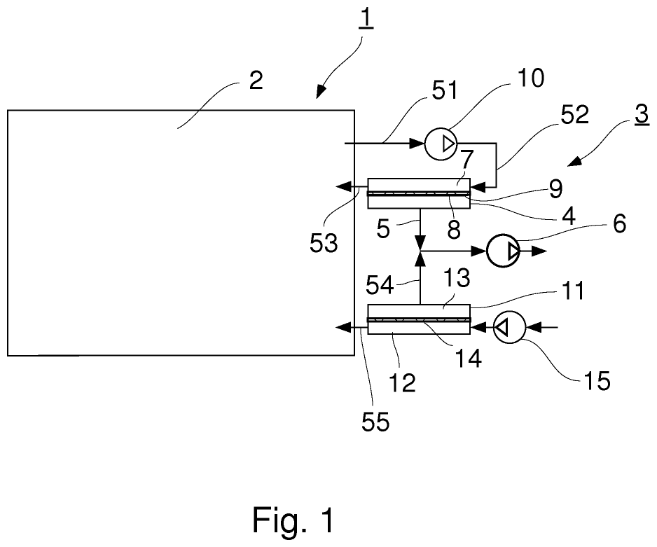

FIG. 1 shows a reefer container for shipping perishable products such as fruit and vegetables comprising equipment for establishing and maintaining a controlled atmosphere within the container using two selective units; and

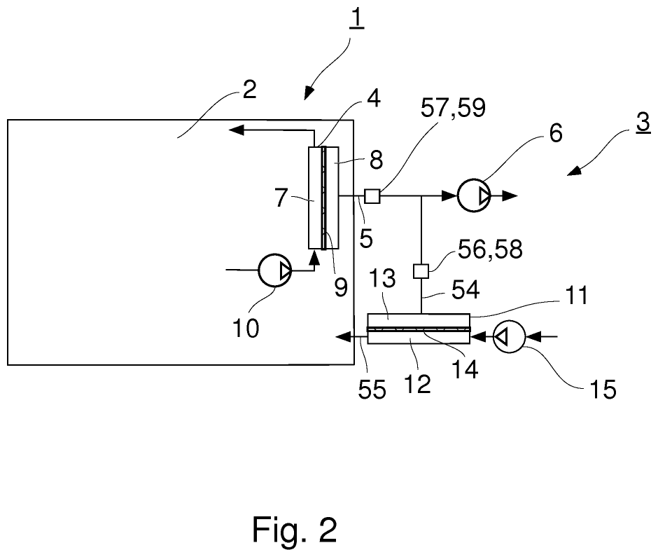

FIG. 2 shows an embodiment of FIG. 1, where one selective unit is placed within the cargo space of the container.

Various embodiments are described hereinafter with reference to the figures. Like reference numerals refer to like elements throughout. Like elements will, thus not be described in detail with respect to the description of each figure.

It should also be noted that the figures are only intended to facilitate the description of the embodiments.

They are not intended as an exhaustive description of the claimed invention or as a limitation on the scope of the claimed invention. In addition, an illustrated embodiment needs not have all the aspects or advantages shown.

An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

In FIG. 1 is shown a reefer container 1 with a space 2 for shipping perishable products such as fruit and vegetables. The container 1 is provided with equipment 3 for establishing and maintaining a controlled atmosphere within the container 1. The controlled atmosphere is meant to establish an atmosphere within the container 1 having a content of oxygen in a range of 1-10%, preferably 2-5% and a content of carbon dioxide in a range of 0-10%, preferably 2-6%.

In the following, the embodiments described are using membranes in the first and second selective units 4, 11 even though an absorber can be used as a selective element.

When using an absorber (not shown) for removing carbon dioxide from a gas stream by adsorption on to a solid adsorbent two methods are commonly used. The methods are temperature swing adsorption (TSA) and pressure swing adsorption (PSA). In both techniques, a bed of adsorbent is exposed to a flow of gas from inside the container and forced by a pressure difference above and below the evaporator fans for a period to adsorb carbon dioxide from the gas stream. Then, the flow of gas is shut off from the adsorbent bed and the adsorbent is exposed to a flow of heated ambient air forced by fans, which heated ambient air strips the adsorbed gas (and water) from the adsorbent and regenerates it for further use. In TSA, the heat needed to desorb the carbon dioxide (and the water) from the adsorbent in the regeneration phase is supplied by heated regenerating gas. In PSA, the pressure of the gas stream is lower than that of the feed gas and the change in pressure is used to remove the carbon dioxide (and water) from the adsorbent with the heat required for desorption being supplied by the heat of adsorption retained within the bed.

Generally, the pressure of the regenerating gas is lower than that of the feed gas in TSA also. However, in a TSA process, the adsorption phase is carried on for a prolonged period and the heat of adsorption of the carbon dioxide and water on the adsorbent liberated during most of the adsorption phase is displaced out of the bed by the flow of gas. It is necessary that the adsorbent bed has a substantial capacity for adsorbing carbon dioxide (and water).

An example of adsorbent used for the bed can be activated charcoal.

An alternative can be to use a gas selective membrane.

A gas selective membrane 9, 14 operates with a pressure difference between a primary 7, 12 and a secondary side 8, 13, here being a feed side 7, 12 and a permeate side 8, 13 as a driving force is gas partial pressure.

An up-concentration requires therefore a pressure difference from the feed side 7, 12 to the permeate side 8, 13 of the membrane 9, 14.

As an example following values can illustrate a composition of gasses within a container with a controlled atmosphere system:

When the primary membrane selectively removes carbon dioxide (a permeate concentration of 30-50% when setpoint=5% carbon dioxide) and oxygen (a permeate concentration of approx. 5% when setpoint=3% oxygen and 5% carbon dioxide) from the container atmosphere, this volume will be replaced by ambient air containing 21% oxygen.

By having a secondary membrane 14 for nitrogen enrichment operated with the same vacuum pump 6 as the first membrane 9 the replacement atmosphere can contain 2-5% oxygen instead of 21% thereby making the overall oxygen mass balance more tolerant to low commodity respiration and to air leakages through the container wall or container doors. Further by providing a positive flow of nitrogen enriched atmosphere to the container, the leakages will be outgoing of the container instead of ingoing.

A reefer container 1 according to the invention has a controlled atmosphere system 3 comprising:
a first selective unit 4 comprising an absorber or a membrane 9 being selective for carbon dioxide over oxygen and nitrogen;
a second selective unit 11 comprising an absorber or a membrane 14 being selective for oxygen over nitrogen; and
a vacuum pump 6 for extracting and removing separated gasses from a permeate side 8, 13 of the first and second selective units 4, 11 to outside the container 1,
   where the system 3 further comprises a pump 15 for providing an overpressure in the container 1.

In an embodiment, the pump 15 is connected to the container 1 through a feed side 12 of the second selective unit 11.

In an embodiment, the pump 15 is a positive displacement pump.

In an embodiment, flow of enriched nitrogen pressed into container 1 by the pump 15 is larger than flow out of container from the permeate side 8 of the first selective unit 4.

In an embodiment, flow of enriched nitrogen pressed into container 1 by the pump 15 is 10% larger than flow out of container from the permeate side 8 of the first selective unit 4.

In an embodiment, flow of enriched nitrogen pressed into container 1 by the pump 15 is 25% larger than flow out of container from the permeate side 8 of the first selective unit 4.

In an embodiment, flow of enriched nitrogen pressed into container 1 by the pump 15 is 50 litre per hour (L/h) larger, preferable 100 L/h larger, more preferable 200 L/h larger than flow out of container from the permeate side 8 of the first selective unit 4.

In an embodiment the flow of enriched nitrogen pressed into container 1 by the pump 15 is more than 200 L/h larger than flow out of container 1 from the permeate side 8 of the first selective unit 4.

In an embodiment, the vacuum pump 6 for removing permeate from the selective units 4, 11 is driven by a shaft also driving the pump 15 forcing ambient atmosphere through the feed side 12 of the second membrane unit 11.

In an embodiment, the first selective unit 4 is placed in a cargo space 2 of the container 1.

A method according to the invention controls the atmosphere within a reefer container 1 having a controlled atmosphere system 3 comprising:
a first selective unit 4 comprising an absorber or a membrane 9 being selective for carbon dioxide over oxygen and nitrogen;
a second unit 11 comprising an absorber or a membrane 14 being selective for oxygen over nitrogen; and
a vacuum pump 6 extracting and removing separated gasses from a permeate side 8, 13 of the first and second selective units 4, 11 to outside the container 1;
   where an overpressure is provided in the container through the second selective unit by a pump.

When ripening produce begins to increase production of carbon dioxide, the controlled atmosphere system 3 by means of a first selective unit 4 comprising an absorber or a membrane 9 being selective for carbon dioxide over oxygen, can adjust the carbon dioxide content within the load space 2 of the container 1.

A second selective unit 11 comprising an absorber or a membrane 14 being selective for oxygen over nitrogen can adjust the nitrogen content within the load space 2 of the container 1.

The first and second selective units 4, 11 are via pipes 5, 54 connected to a vacuum pump 6.

Carbon dioxide will be removed through the first selective unit 4 via the pipe 5 and the vacuum pump 6 and led to ambient atmosphere.

The first selective unit 4 is divided in a feed side 7 and a permeate side 8 by a first membrane 9.

The feed side 7 being the side from where gas to be controlled passes over the first membrane 9 and the permeate side is the opposite side of the first membrane 9, from where permeate or “extracted” gas, here carbon dioxide, is directed to the ambient atmosphere by the vacuum pump 6.

The feed side 7 of the first selective unit 4 is in fluid connection with the cargo space 2 of the container 1 via pipes 51, 52, 53 and can further be provided with a ventilator or pump 10, forcing a flow of gas from the cargo space 2 of the container 1 through feed side 7 of the first selective unit 4 and back into the cargo space 2 of the container 1.

A second selective unit 11 is divided in a feed side 12 and a permeate side 13 by a second membrane 14. The permeate side 13 of the second selective unit 11 is in fluid connection with the vacuum pump 6 via a pipe 54. Removing oxygen from ambient air forced into the cargo space 2 of the container 1 by a pump 15 results in a rise of nitrogen content within the cargo space 2 of the container 1.

Nitrogen enriched ambient air is forced into the cargo space 2 of the container 1 via a pipe 55 or other fluid connection from the feed side 12 of the second selective unit 11.

In an embodiment the pump 15 is placed in fluid connection with the pipe 55 downstream the selective unit 11 and upstream the container 1.

In an embodiment valves 56, 57 and/or sensors 58, 59 are placed in or on the pipes 5, 54 between the permeate sides 9, 14 of the selective units 4, 11 and the vacuum pump 6.

Valves 56, 57 and/or sensors 58, 59 communicates with a controller (not shown) controlling the controlled atmosphere system 3.

What is claimed is:

1. A reefer container having a controlled atmosphere system comprising:
a first selective unit comprising an absorber or a membrane being selective for carbon dioxide over oxygen and nitrogen;
a second selective unit comprising an absorber or a membrane being selective for oxygen over nitrogen; and
a vacuum pump for extracting and removing separated gasses from a permeate side of the first and second selective units to outside the container,
characterized in that the system is further comprising a pump for providing an overpressure in the container.

2. The reefer container according to claim 1, characterized in that the pump is connected to the container through a feed side of the second selective unit.

3. The reefer container according to claim 1, characterized in that the pump is a positive displacement pump.

4. The reefer container according to claim 1, characterized in that flow of enriched nitrogen pressed into container by the pump is larger than flow out of container from the permeate side of the first selective unit.

5. The reefer container according to claim 1, characterized in that flow of enriched nitrogen pressed into container by the pump is 10% larger than flow out of container from the permeate side the first selective unit.

6. The reefer container according to claim 1, characterized in that flow of enriched nitrogen pressed into container by the pump is 25% larger than flow out of container from the permeate side the first selective unit.

7. The reefer container according to claim 1, characterized in that flow of enriched nitrogen pressed into container by the pump is 50 litre per hour (L/h) larger, preferable 100 L/h larger, more preferable 200 L/h larger than flow out of container from the permeate side the first selective unit.

8. The reefer container according to claim 1, characterized in that flow of enriched nitrogen pressed into container by the pump is more than 200 L/h larger than flow out of container from the permeate side of the first selective unit.

9. The reefer container according to claim 1, characterized in that the vacuum pump for removing permeate from the selective units is driven by a shaft also driving the pump forcing ambient atmosphere through the feed side of the second membrane unit.

10. The reefer container according to claim 1, characterized in that the first selective unit is placed in a cargo space of the container.

11. A method of controlling the atmosphere within a reefer container having a controlled atmosphere system, which comprises:
a first selective unit comprising an absorber or a membrane being selective for carbon dioxide over oxygen and nitrogen;
a second selective unit comprising an absorber or a membrane being selective for oxygen over nitrogen; and
a vacuum pump extracting and removing separated gasses from a permeate side of the first and second selective units to outside the container,
the method comprising: providing an overpressure in the container through the second selective unit by use of a pump.

12. The method according to claim 11 comprising connecting the pump to the container through a feed side of the second selective unit.

13. The method according to claim 11 comprising adjusting a flow of enriched nitrogen passed into the container by the pump to be larger than the flow out of the container from the permeate side of the first selective unit.
